(19) United States
(12) Patent Application Publication
(10) Pub. No.: US 2008/0248223 A1
(43) Pub. Date: Oct. 9, 2008

(54) EPOXY URETHANE COATED CERAMIC ARTICLE

(76) Inventors: Ken W. Niederst, Allison Park, PA (US); John R. Zern, Cheswick, PA (US); Venkatachalam Eswarakrishnan, Allison Park, PA (US); Robert B. Hodek, Sarver, PA (US); Terence J. Hart, Pittsburgh, PA (US)

Correspondence Address: PPG INDUSTRIES INC;INTELLECTUAL PROPERTY DEPT, ONE PPG PLACE, PITTSBURGH, PA, 15272, US

(21) Appl. No.: 11/695,845

(22) Filed: Apr. 3, 2007

(51) Int. Cl. B05D 7/14; A47G 19/22

(52) U.S. Cl. 428/34.7; 106/287.22

(57) ABSTRACT

A coated ceramic article wherein the coating comprises an epoxy urethane resin is disclosed.

### FIELD OF THE INVENTION

The present invention is directed to a coated ceramic article, wherein the coating comprises an epoxy urethane resin.

### BACKGROUND OF THE INVENTION

It is often desired to put one or more various coatings on ceramic articles for decorative and/or protective purposes. For example, if the ceramic article is a food container, a coating can provide both protection to the food as well as the container. Ceramic articles can become scratched and/or abraded. Such scratching and/or abrasion reduces the strength of the ceramic material. The “burst strength” of a ceramic article, such as a glass bottle or other container refers to the amount of pressure that will cause the ceramic article to shatter. The burst strength of a ceramic article is particularly relevant for ceramic articles that are reused, such as refillable bottles. Refillable bottles undergo significant handling. For example, the bottles are typically pressurized and filled once, and distributed to consumers, who return the bottles for reuse. The returned bottles are typically subjected to a caustic wash, in which they are exposed to heated, highly basic pH solutions for several minutes. The washed and rinsed bottles are then subjected once again to a pressurization and filling step. The caustic wash, as well as various scratches and abrasions that the bottle may undergo during all of the handling stages, contribute to the lowering of the burst strength of the bottle. It is therefore desired to enhance the burst strength of a ceramic article.

### SUMMARY OF THE INVENTION

The present invention is directed to a coated ceramic article, wherein the coating comprises an epoxy urethane resin.

### DETAILED DESCRIPTION OF THE INVENTION

The present invention is directed to a coated ceramic article wherein the coating comprises an epoxy urethane resin. The epoxy urethane resin can be any epoxy urethane known in the art, such as those described in U.S. Pat. No. 4,017,438, incorporated by reference herein. For example, a suitable epoxy urethane resin can be prepared by reacting an epoxy resin with an amine and adding a suitable crosslinker, such as an isocyanate-containing crosslinker or carbonate/amine reaction product. Suitable epoxy resins include, for example, an adduct of a primary and/or secondary amine with an epoxy group-containing resin. The epoxy material utilized to form the adduct can be any monomeric or polymeric compound or mixture of compounds having an average of one or more epoxy groups per molecule. The monoepoxides can be utilized, but the epoxy compound may be resinous, with the polyepoxide containing one or more epoxy groups per molecule. A particularly useful class of polyepoxides are the polyglycidyl ethers of polyphenols such as Bisphenol A. These can be produced, for example, by etherification of a polyphenol with epichlorohydrin or dichlorohydrin in the presence of an alkali. The phenolic compound may be, for example, bis(4-hydroxyphenyl)2,2-propane, 4,4′-dihydroxybenzophenone, bis(4-hydroxyphenyl)1,1-ethane, bis(4-hydroxyphenyl) 1,1-isobutane, bis(4-hydroxytertiarybutylphenyl)2,2-propane, bis(2-hydroxynaphthyl)methane 1,5-dihydroxynaphthylene, or the like. In many instances it is desirable to employ such polyepoxides having somewhat higher molecular weight and containing aromatic groups. These can be provided by reacting the diglycidyl ether above with a polyphenol such as Bisphenol A and then further reacting this product with epichlorohydrin to produce a polyglycidyl ether. The polyglycidal ether of a polyphenol can contain free hydroxyl groups in addition to epoxide groups.

Also suitable are the similar polyglycidyl ethers of polyhydric alcohols that may be derived from such polyhydric alcohols as ethylene glycol, diethylene glycol, triethylene glycol, 1,2-propylene glycol, 1,4-propylene glycol, 1,5-pentanediol, 1,2,6-hexanetriol, glycerol, bis(4-hydroxycyclohexyl)2,2-propane and the like. There can also be used polyglycidyl esters of polycarboxylic acids, which are produced by the reaction of epichlorohydrin or similar epoxy compounds with an aliphatic or aromatic polycarboxylic acid such as oxalic acid, succinic acid, glutaric acid, terephthalic acid, 2,6-naphthylene dicarboxylic acid, dimerized linolenic acid and the like. Examples are glycidyl adipate and glycidyl phthalate. Also useful are polyepoxides derived from the epoxidation of an olefinically unsaturated alicyclic compound. Included are diepoxides comprising in part one or more monoepoxides. These polyepoxides are non-phenolic and are obtained by the epoxidation of alicyclic olefins, for example, by oxygen and selected metal catalysts, by perbenzoic acids, by acetaldehyde monoperacetate, or by peracetic acid. Among such polyepoxides are the epoxy alicyclic ethers and esters, which are well known in the art.

Other epoxy-containing compounds are resins including nitrogeneous diepoxides such as disclosed in U.S. Pat. No. 3,365,471; epoxy resins from 1,1-methylene bis(5-substituted hydantoin), U.S. Pat. No. 3,391,097; bis-imide containing diepoxides, U.S. Pat. No. 3,450,711; epoxylated aminomethyldiphenyl oxides, U.S. Pat. No. 3,312,664; heterocyclic N,N′-diglycidyl compounds, U.S. Pat. No. 3,503,979; amino epoxy phosphonates, British Pat. No. 1,172,916; 1,3,5-triglycidyl isocyanurates, as well as other epoxy-containing materials known in the art; all of these references are incorporated herein.

In certain embodiments, the epoxy urethane resin can be made water soluble, such as by formation of a cationic salt of the epoxy urethane resin. For example, the epoxy-containing materials can be reacted with an amine to form an adduct. The amine employed may be any primary or secondary amine. The amine can be a water-soluble amino compound. Examples of such amines include mono- and dialkylamines such as methylamine, ethylamine, propylamine, butylamine, dimethylamine, diethylamine, dipropylamine, dibutylamine, methylbutylamine, ketimines such as the ketimine of diethylene triamine, and the like. Alternatively, the amine can be a tertiary amine, in which a quaternary ammonium cationic salt will form; a sulfonium and/or phosphonium containing material can be used in place of or in addition to an amine, thereby forming a ternary sulfonium and/or phosphonium cationic salt. The amine group can also be present on an amide, such as a polyamide, an example of which would be the reaction product of a dimer acid and ethylenediamine. Imines could also be used.

While in most instances reasonably low molecular weight amines may be employed, it is possible to employ higher molecular weight monoamines, especially if it is desired that the molecule be flexibilized or further modified by the structure contributed by the amines. Likewise, a mixture of low molecular weight and high molecular weight amines may be employed to modify the resin properties.

Further, it is possible for the amines to contain other constituents so long as they do not interfere with the reaction of the amine and the epoxy group and are of the nature or employed under the conditions so that they do not gel the reaction mixture.

The reaction of the amine with the epoxy group-containing material takes place upon admixing the amine and the epoxy group-containing material. It may be exothermic. If desired, the reaction mixture, if necessary, may be heated to moderate temperature, that is, 50° C. to 150° C., although higher or lower temperatures may be used, depending on the desired reaction. It is frequently desirable, in any event, at the completion of the reaction to elevate the temperature at least slightly for a sufficient time to insure complete reaction.

The amount of amine reacted with the epoxy group-containing material is at least that amount sufficient to render the resin cationic in character. In certain embodiments, substantially all of the epoxy groups in the resin are reacted with an amine. Suitable commercially available epoxy resins include, for example, bisphenol A and bisphenol F type EPON products from Hexion, hydrogenated bisphenol A and bisphenol F type EPONEX products such as EPONEX 1510 also from Hexion, aliphatic based epoxy resins from CVC and cycloaliphatic type epoxy resins, such as ERL4221, from Dow.

Suitable isocyanates include aliphatic isocyanates such as trimethylene, tetramethylene, pentamethylene, hexamethylene, 1,2-propylene, 1,2-butylene, 2,3-butylene, ethylidine and butylidene diisocyanates; the cycloalkylene compounds such as 1,3-cyclopentane, 1,4-cyclohexane, and 1,2-cyclohexane diisocyanates; the aromatic isocyanates such as m-phenylene, p-phenylene, 4,4′-diphenyl, 1,5-naphthalene and 1,4-naphthalene diisocyanates; the aliphatic-aromatic isocyanates such as dianisidine diisocyanate, 4,4′-diphenylene methane, 2,4- or 2,6-tolylene, or mixtures thereof, 4,4′-toluidine, and 1,4′-xylene diisocyanates; the nuclear-substituted aromatic isocyanates such as dianisidine diisocyanate, 4,4′-diphenylether diisocyanate and chlorodiphenylene diisocyanate; the triisocyanates such as triphenyl methane-4,4′,4″-triisocyanate, 1,3,5-triisocyanate benzene and 2,4,6-triisocyanate toluene; and the tetraisocyanates such as 4,4′-diphenyl-dimethylmethane-2,2′,5,5′tetraisocyanate, the polymerized polyisocyanates such as tolylene diisocyanate dimers and trimers, and the like.

In addition, the organic polyisocyanate may be a prepolymer derived from a polyol including polyether polyol or polyester polyol, including polyethers that are reacted with excess polyisocyanates to form isocyanate-terminated prepolymers, may be simple polyols such as glycols, e.g., ethylene glycol and propylene glycol, as well as other polyols such as glycerol, trimethylolpropane, hexanetriol, pentaerythritol, and the like, as well as mono-ethers such as diethylene glycol, tripropylene glycol and the like, and polyethers, i.e., alkylene oxide condensates of the above. Among the alkylene oxides that may be condensed with these polyols to form polyethers are ethylene oxide, propylene oxide, butylene oxide, styrene oxide and the like. These are generally called hydroxy-terminated polyethers and can be linear or branched. Examples of polyethers include polyoxyethylene glycol having a molecular weight of 1540, polyoxypropylene glycol having a molecular weight of 1025, polyoxytetramethylene glycol, polyoxyhexamethylene glycol, polyoxynonamethylene glycol, polyoxydecamethylene glycol, polyoxydodecamethylene glycol and mixtures thereof. Other types of polyoxyalkylene glycol ethers can be used. Especially useful polyether polyols are those derived from reacting polyols such as ethylene glycol, diethylene glycol, triethylene glycol, 1,4-butylene glycol, 1,3-butylene glycol, 1,6-hexanediol, and their mixtures; glycerol, trimethylolethane, trimethylolpropane, 1,2,6-hexanetriol, pentaerythritol, dipentaerythritol, tripentaerythritol, polypentaerythritol, sorbitrol, methyl glucosides, sucrose and the like, with alkylene oxides such as ethylene oxide, propylene oxide, their mixtures, and the like.

Such isocyanates are commercially available from Bayer in its DESMODUR line. In certain embodiments, the isocyanate is a blocked isocyanate. Any suitable aliphatic, cycloaliphatic or aromatic alkyl monoalcohol may be used as a blocking agent in accordance with the present invention, such as, for example, lower aliphatic alcohols, such as methyl, ethyl, chloroethyl, propyl, butyl, amyl, hexyl, heptyl, octyl, nonyl, 3,3,5-trimethylhexanol, decyl and lauryl alcohols, and the like; the aromatic-alkyl alcohols, such as phenylcarbinol, methylphenylcarbinol, ethylene glycol monoethyl ether, glycol monobutyl ether and the like.

Additional blocking agents include tertiary hydroxylamines such as diethylethanolamine and oximes such as methylethyl ketone oxime, acetone oxime, cyclohexanone oxime and caprolactam.

The organic polyisocyanate-blocking agent adduct is formed by reacting a sufficient quantity of blocking agent with the organic polyisocyanate to insure that substantially no free isocyanate groups are present. The reaction between the organic polyisocyanate and the blocking agent is often exothermic; therefore the polyisocyanate and the blocking agent can be admixed at temperatures no higher than 80° C., such as below 50° C. to minimize the exotherm effect. Blocked isocyanates are commercially available from Bayer in their DESMODUR line.

The epoxy amine adduct and isocyanate can be reacted in any ratio that will give a suitable epoxy urethane resin. For example, the ratio of isocyanate to epoxy can be 40-60:60-40, such as 55:45.

The solubility of the epoxy urethane resin in water can be achieved by preparing a cationic salt of the epoxy urethane. The cationic salt can be prepared by neutralizing the resin with an acid, such as acetic, lactic, sulfamic, formic, or any other volatile acid that would tend to leave the film during a 175°-205° C. bake.

The molecular weight of the cationic salt of an epoxy urethane resin as used in the present coatings can be 8,000 to 14,000, such as 10,000 to 12,000, with molecular weight referring to the weight average molecular weight.

The coating is most typically a water borne coating, comprising 30 to 50, such as 40 to 50% solids, of which 60 to 95, such as 80 to 90%, comprises a cationic salt of the epoxy urethane resin as described above. In ceramic and/or glass forming operations, where open flame may be used, water borne coatings are typically desired. “Water borne” means that the nonsolid portion of the coating is 50% or more water. In some embodiments, the nonsolid portion of the coating may be at least 80% water, such as at least 95% water. In certain applications some solvent may be used even in water borne coatings. Suitable solvents include lower alcohols, glycol ethers, aromatics and ketones. In certain other applications, however, solvent borne coatings may be desired. “Solvent borne” means that the nonsolid portion of the coating is 50% or more organic solvent.

The present coatings can further comprise one or more additives that are standard in the art such as one or more of surfactants, wetting agents, catalysts, film-build additives, flatting agents, defoamers, UV absorbers, hindered amine light stabilizers (“HALS”), adhesion promoters, flow additives, lubricants, colorants and the like. Suitable UV absorbers include those available from Ciba-Geigy in its TINUVIN line, such as TINUVIN 1130, TINUVIN 328 and TINUVIN 327. Suitable HALS include TINUVIN 123 and TINUVIN 292. Suitable adhesion promoters include epoxy silane adhesion promoters, such as A187, commercially available from Union Carbide, and also epoxy silane adhesion promoters from GE. Suitable lubricants include nylon beads, such as those commercially available from Atofina in its ORGASOL line, waxes, such as those commercially available from BARECO, Michelman, Daniels Products, and Micropowders. In certain embodiments, such as if the coated ceramic article will be exposed to sunlight or other UV light, it is particularly suitable to use both a UV absorber and a HALS to minimize delamination and improve caustic wash resistance.

The coatings used according to the present invention can also include a colorant. As used herein, the term “colorant” means any substance that imparts color and/or other opacity and/or other visual effect to the composition. The colorant can be added to the coating in any suitable form, such as discrete particles, dispersions, solutions and/or flakes. A single colorant or a mixture of two or more colorants can be used in the coatings of the present invention.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coatings by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black, pthalo green or blue, iron oxide and mixtures thereof. The terms “pigment” and “colored filler” can be used interchangeably.

Example dyes include, but are not limited to, those that are solvent and/or aqueous based such as acid dyes, azoic dyes, basic dyes, direct dyes, disperse dyes, reactive dyes, solvent dyes, sulfur dyes, mordant dyes, for example, bismuth vanadate, anthraquinone, perylene, aluminum, quinacridone, thiazole, thiazine, azo, indigoid, nitro, nitroso, oxazine, phthalocyanine, quinoline, stilbene, and triphenyl methane.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in United States Patent Application Publication 2005-0287348 A1, filed Jun. 24, 2004, U.S. Provisional Application No. 60/482,167 filed Jun. 24, 2003, and U.S. patent application Ser. No. 11/337,062, filed Jan. 20, 2006, which is also incorporated herein by reference.

Example special effect compositions that may be used in the coating of the present invention include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as opacity or texture. In a non-limiting embodiment, special effect compositions can produce a color shift, such that the color of the coating changes when the coating is viewed at different angles. Example color effect compositions are identified in U.S. Pat. No. 6,894,086, incorporated herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In certain non-limiting embodiments, a photosensitive composition and/or photochromic composition, which reversibly alters its color when exposed to one or more light sources, can be used in the coating of the present invention. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. In one non-limiting embodiment, the photochromic and/or photosensitive composition can be colorless in a non-excited state and exhibit a color in an excited state. Full color-change can appear within milliseconds to several minutes, such as from 20 seconds to 60 seconds. Example photochromic and/or photosensitive compositions include photochromic dyes.

In a non-limiting embodiment, the photosensitive composition and/or photochromic composition can be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with a non-limiting embodiment of the present invention, have minimal migration out of the coating. Example photosensitive compositions and/or photochromic compositions and methods for making them are identified in U.S. application Ser. No. 10/892,919 filed Jul. 16, 2004 and incorporated herein by reference. In general, the colorant can be present in the coating composition in any amount sufficient to impart the desired visual and/or color effect. The colorant may comprise from 1 to 65 weight percent of the present compositions, such as from 3 to 40 weight percent or 5 to 35 weight percent, with weight percent based on the total weight of the compositions.

As noted above, the present invention is directed to coated ceramic articles. As used herein, the term “ceramic” refers to a wide range of substrates generally characterized as brittle, heat resistant, and/or formed from one or more non-metallic minerals, including but not limited to pottery, earthenware, clay, whiteware, refractories, porcelain, glass ceramic and glass. The ceramic articles of the present invention can be glazed or unglazed, and can be in any shape, size and/or configuration. The term “article” refers to any ceramic product such as food containers, prescription lenses, imaging lenses, optical fibers, and automobile and building windows, for example. A “food container” is any container in which food and/or beverage is served, stored and/or shipped. In certain embodiments, the food container is a glass article, such as a glass jar, glassware including but not limited to drinking or wine glasses, glass jugs, or glass dinnerware. In a particular embodiment, the ceramic article is a glass bottle. The ceramic article according to the present invention can be clear or opaque, and can be colored or not colored.

The manufacture of glass bottles will be well known to those skilled in that art. In certain embodiments, the glass may be strengthened in some manner, such as by annealing the glass and/or chemically strengthening the glass. Suitable methods for annealing and/or chemically strengthening the glass are discussed in a number of U.S. patents and applications.

As will be further understood by those skilled in the art of bottle making, bottles may be subjected to one or more of various coatings, such as a hot end coating and/or a cold end coating. The hot end coating, as the name implies, is applied to the bottle while it is still hot (i.e. 400-630° C.). A typical hot end coating is a tin oxide coating. The cold end coating is typically applied to the bottle after it has cooled significantly (i.e. to a temperature of about 80-150° C.). Typical cold end coatings can include, for example, wax emulsions, stearic acid, or silane coatings.

The coatings used according to the present invention can be used, if desired, with a hot end coating and/or a cold end coating, or any various other coatings. In certain embodiments, however, the use of a fatty acid containing coating in conjunction with the epoxy urethane coating is specifically excluded. For example, a primer layer can be applied to the bottle prior to the application of the epoxy urethane coating described herein. A suitable primer is described in U.S. Pat. No. 5,776,548, the contents of which are hereby incorporated by reference.

The coatings of the present invention can also be used in combination with one or more decorative coatings. Particularly suitable as a decorative coating are UV curable inks. Other suitable decorative coatings include those comprising a reactive organic resin, a reactive wax, and a blocked isocyanate, such as those described in U.S. Pat. No. 6,214,414 B1, incorporated by reference herein, and pigmented or nonpigmented compositions comprising an organic binder and a rigid organic and/or inorganic particle, such as particles that are rigid at or below a first temperature and that soften at a second temperature at or above the temperature at which the binder cures. Such coatings are described in U.S. Publication Nos. 2004/0058144, 2005/0025891 and 2005/0069714, all of which are incorporated by reference herein. In this embodiment, the decorative coating can be applied to the bottle first, followed by the epoxy urethane coating described above.

The epoxy urethane coatings of the present invention can be applied by any means known in the art such as by spraying or dipping. The viscosity of the coating can be adjusted as necessary by adding water or organic solvent to achieve the desired viscosity. Any spraying or dipping means known in the art can be used. The coatings of the present invention are typically applied to bottles that are unheated, that is, bottles that are at a temperature of 20° C. to 40° C. Any film build can be used according to the present invention, such as 0.01 to 2.0 mils dry film thickness (“DFT”); a particularly suitable DFT is 0.6 mils to 2 mils such as 0.7 to 1.5 mils. In certain embodiments, the coating has a DFT of less than 50 microns (i.e. about 2 mils), such as less than 20 microns (i.e. about 0.8 mils). It will be appreciated by those skilled in the art that the coating used according to the present invention is a thermoset coating, and not a plastic, rubber, or elastomeric-polymeric coating or film. This will be apparent from the chemical description of the coating.

The coated ceramic articles of the present invention find particular application as refillable glass bottles. As noted above, these bottles undergo significant handling and exposure to caustic for often as many as 25 cycles. In certain embodiments, the glass bottle is a light weight glass bottle. In certain embodiments, the coated ceramic articles show caustic resistance and/or resistance to scratching and/or abrasion. Coated ceramic articles according to the present invention, particularly coated glass bottles, show enhanced burst strength as compared to similar ceramic articles that are uncoated. For example, a pristine glass bottle having little to no abrasion will typically have a burst strength of 450 to 500 psi. The coated bottle of the present invention can have a burst strength of 200 psi or greater after 20 or more cycles. A similar bottle that is uncoated may exhibit only a few cycles prior to bursting at the same or lower burst pressure. Burst pressure can be measured using equipment available from American Glass Research, according to ASTM C 147-86 (2005) (Internal Pressure Resistance (Hydrolytic):Glass).

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. Plural encompasses singular and vice versa. Therefore, while reference is made herein, including the claims, to “a” cationic salt, “an” epoxy urethane resin, “an” epoxy, “an” amine, “an” isocyanate, “a” UV absorber, “a” hindered amine light stabilizer one or more of these things can be used; similarly, one or more of any of the components described herein can be used in the present coatings.

### EXAMPLES

The following examples are intended to illustrate the invention, and should not be construed as limiting the invention in any way.

### Example 1

A coating according to the present invention was prepared as follows: To 222.30 grams of an epoxy urethane WE-35-3000* (obtained from PPG) (42.96% total solids (“TS”)) containing as additives 0.98% on resin solids TINUVIN 123 (Ciba-Geigy) and 0.25% of MEKON white wax—T-2 grade (Bareco)). To the mixture was added, with mild stirring, 3.03 grams of Z-6040 epoxy silane (GE), and also added with mild stirring were 1.50 grams of TINUVIN 1130 (Ciba-Geigy).

The coating had approximately 44% total solids. The coating was spray applied at ambient temperature using a Binks model 62 air atomizing spray gun onto tin oxide hot end coating containing light weighted glass bottles (250 ml size) to an average dry film thickness of about 0.7 to 1.5 mils. The coating flashed for several minutes at ambient condition before being baked in a gas fired hot air convection oven set at an air temperature of 175-205° C. for 45 minutes.

*WE-35-3000—contains the following base resin components in parts by weight:

Amine functionalized epoxy (epoxy equivalent weight˜935)—43.7 parts

Bisphenol A/ethylene oxide polyol (I mole/6 mole)—11.3 parts

Caprolactam capped DESMODUR N-3300(HDI Trimer from Bayer)—45.parts

Amine groups were neutralized to about 40-46% theoretical neutralization with acetic acid.

### Example 2

Bottles prepared as generally described above using a coating according to the present invention where subjected to a standard loop trial, in which the cycle of pressurizing, filling, emptying and hot caustic washing of a refillable bottle was simulated. The bottles coated according to the present invention had a much lower failure rate than uncoated bottles after several cycles.

Therefore we claim:

1. A coated ceramic article, wherein the coating comprises an epoxy urethane resin.

2. The article of claim 1, wherein the coating is formed by reacting an epoxy resin with an isocyanate.

3. The article of claim 2, wherein the epoxy resin further comprises one or more polyols.

4. The article of claim 3, wherein one of the polyols comprises bisphenol A.

5. The article of claim 2, wherein the epoxy has been chain extended with an amine.

6. The article of claim 5, wherein the amine comprises diethylamine.

7. The article of claim 2, wherein the isocyanate is a blocked isocyanate.

8. The article of claim 5, wherein a cationic salt is formed from neutralizing the amine moiety on the epoxy urethane resin with an acid.

9. The article of claim 8, wherein the acid comprises acetic acid, lactic acid and/or sulfamic acid.

10. The article of claim 1, wherein the weight average molecular weight of the resin is 8,000 to 14,000.

11. The article of claim 1, wherein the ceramic article is a glass bottle.

12. The glass bottle of claim 11, wherein the glass is annealed.

13. The glass bottle of claim 11, wherein the glass bottle is chemically strengthened prior to coating.

14. The glass bottle of claim 13, wherein the glass bottle is annealed.

15. The glass bottle of claim 11, wherein the glass bottle has a hot end coating and/or a cold end coating applied thereto.

16. The glass bottle of claim 15, wherein the hot end coating comprises tin oxide.

17. The glass bottle of claim 15, wherein the cold end coating comprises stearic acid.

18. The coated ceramic article of claim 1, wherein the ceramic article is a food container.

19. The coated food container of claim 18, wherein the coating is water borne.

20. The glass bottle of claim 11, wherein the coating is water borne.

21. The ceramic article of claim 1, wherein the coating has a dry film thickness of less than 50 microns.

22. The glass bottle of claim 11, wherein the coating has a dry film thickness of less than 50 microns.

23. The ceramic article of claim 1, wherein the coating further comprises a UV absorber and a hindered amine light stabilizer.

24. The glass bottles of claim 11, wherein the coating further comprises a UV absorber and a hindered amine light stabilizer.

25. The ceramic article of claim 1, wherein a decorative coating is applied to at least a portion of the ceramic article.

26. The ceramic article of claim 25, wherein the decorative coating comprises an organic binder and a plurality of organic and/or inorganic particles that are rigid at or below a first temperature and that soften at or above a second temperature at which the binder cures.

27. The glass bottle of claim 11, wherein a decorative coating is applied to at least a portion of the ceramic article.

28. The glass bottle of claim 27, wherein the decorative coating comprises an organic binder and a plurality of organic and/or inorganic particles that are rigid at or below a first temperature and that soften at or above a second temperature at which the binder cures.
